(19) United States
(12) Patent Application Publication
(10) Pub. No.: US 2010/0215388 A1
(43) Pub. Date: Aug. 26, 2010

(54) CHARGING DEVICE CONTROLLER FOR CONTROLLING CHARGING DEVICE, ELECTROPHOTOGRAPHIC IMAGE FORMING APPARATUS INCORPORATING THE CHARGING DEVICE AND THE CHARGING DEVICE CONTROLLER, AND CONTROL METHOD FOR CONTROLLING THE CHARGING DEVICE

(76) Inventor: Hiroshi SAITOH, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(21) Appl. No.: 12/700,099

(22) Filed: Feb. 4, 2010

(30) Foreign Application Priority Data
Feb. 26, 2009 (JP) 2009-044176

(51) Int. Cl. G03G 15/02

(52) U.S. Cl. 399/50

(57) ABSTRACT

A charging device controller controls a charging device including a charging roller to charge a surface of an image carrying member carrying a toner image, a cleaning roller to come into contact with the charging roller to remove therefrom foreign substances including toner, and a contact-separation device to make the cleaning roller come into contact with and separate from the charging roller. The charging device controller includes a contact-separation device controller to cause the contact-separation device to make the cleaning roller come into contact with and separate from the charging roller during an image forming operation, which includes a latent image writing operation of writing a latent image on the image carrying member and a development operation of forming a toner image by supplying toner to the latent image, at an operation other than the latent image writing operation performed on the image carrying member.

### CROSS-REFERENCE TO RELATED APPLICATION

The present invention claims priority pursuant to 35 U.S.C. §119 from Japanese Patent Application No. 2009-044176, filed on Feb. 26, 2009 in the Japan Patent Office, which is hereby incorporated by reference herein in its entirety.

### BACKGROUND OF THE INVENTION

1. Field of the Invention

The present invention relates to a charging device controller that controls a charging device, an electrophotographic image forming apparatus incorporating the charging device controller and the charging device, and a control method for controlling the charging device. More particularly, the present invention relates to a charging device controller that controls a charging device including a cleaning roller that comes into contact with a charging roller for charging a surface of an image carrying member to remove foreign substances including toner from the charging roller, an electrophotographic image forming apparatus, such as a multifunctional machine, a copier, a facsimile machine, and a printer, which includes the above-described charging device controller and the above-described charging device, and a control method for controlling the above-described charging device.

2. Discussion of the Background Art

In an electrophotographic image forming apparatus, a development process is performed as follows in a development device, for example. A surface of a photoconductor serving as an image carrying member is charged with a charge of a predetermined polarity and exposed to light reflected by an image surface of a document or light emitted from an exposure device modulated in accordance with image data. The surface of the photoconductor is discharged, and an electrostatic latent image (also sometimes referred to as simply “latent image”) is formed due to a difference in charge over the photoconductor surface. Then, the electrostatic latent image is supplied with toner charged to the same polarity as the charging polarity to form a toner image. Thereafter, the toner image formed on the photoconductor is transferred onto a recording medium such as a recording sheet, and is fixed on the recording medium by heat and pressure. Recently, a contact roller charging method of making the charging roller of the charging device come into contact with and charge the surface of the photoconductor has been often employed in the charging process.

In the above-described development device, post-transfer residual toner remaining on the surface of the photoconductor after the transfer of the toner image is not completely removed by a cleaning process of cleaning the surface of the photoconductor with a cleaning blade or the like. When the photoconductor reaches a position near the charging roller, therefore, the post-transfer residual toner adheres to the surface of the charging roller, causing the charging performance of the charging roller for charging the photoconductor to deteriorate, which in turn may cause a development failure of the development device. In this case, a part of the post-transfer residual toner is charged to the polarity opposite to the intended polarity in the mixing of the toner and a developer. If the toner is charged normally, the toner and the charging roller electrostatically repel each other, and thus the toner is unlikely to adhere to the surface of the charging roller. By contrast, the oppositely charged toner and the charging roller electrostatically attract each other, and thus the toner is likely to adhere to the surface of the charging roller.

In addition to the oppositely charged toner, dust such as paper dust, for example, charged and electrostatically attracting and attracted by the charging roller, adheres to the surface of the charging roller. If the toner, the paper dust, and so forth adhere to the surface of the charging roller, the ability of the charging roller to charge the photoconductor deteriorates, and may cause a development failure of the development device.

Further, to meet increased demand in recent years for high-quality and high-definition images, toner consisting of spherical smaller-diameter particles has been used. The advantage of such toner is that it more finely adheres to the electrostatic latent image and thereby achieves high image quality and high definition. Such spherical smaller-diameter toner particles, however, easily pass beneath the cleaning blade during cleaning of the photoconductor, and thus the surface of the photoconductor is not sufficiently cleaned.

To prevent the post-transfer residual toner not removed by the cleaning process and remaining on the surface of the photoconductor from adhering to the charging roller and degrading the ability of the charging roller to charge the surface of the photoconductor uniformly, adequate cleaning of the surface of the charging roller is necessary.

In view of this, a background method has been proposed, as a charging roller cleaning method, which makes the cleaning roller come into contact with the charging roller, such that the cleaning roller cleans the charging roller while being rotated along with the rotation of the charging roller.

However, in such an arrangement, any post-transfer residual toner relatively firmly adhering to the surface of the charging roller and stains easily deformed or melted by pressure are rubbed or pressed against the surface of the charging roller. As a result, in some cases, therefore, the toner and stains are attached even more firmly to the surface of the charging roller.

Further, it is known that, if a minute gap is set between the surface of the latent image carrying member and the charging roller in a contact-type charging device that applies a voltage superimposed with an alternating-current voltage, the surface of the latent image carrying member is charged by pulse discharge occurring in the minute gap, and thus is constantly etched. As a result, a phenomenon known as film thinning occurs in which the thickness of a photosensitive film forming the surface of the latent image carrying member is reduced, causing deterioration of the charging performance and degradation of the image quality.

To suppress such film thinning of the latent image carrying member, a method has been employed in recent years that coats the surface of the latent image carrying member with a solid lubricant such as zinc stearate, for example, to form a lubricant layer on the surface of the latent image carrying member for enhancing abrasion resistance and protecting the surface.

Due to the coating with the solid lubricant, film thinning is substantially suppressed. However, some of the toner and paper dust adhering to the lower-friction surface of the latent image carrying member still easily passes through a cleaning position together with the lubricant. Thus, in addition to the toner and paper dust as described above, the lubricant also adheres to the charging roller. As a result, in some cases, therefore, the toner and paper dust adhere even more firmly to the surface of the charging roller.

In view of this, another background method has been proposed, as a charging roller cleaning method, which keeps the cleaning roller for cleaning the surface of the charging roller separated from the charging roller as long as the charging roller maintains its ability to charge and when contact of the cleaning roller with the charging roller is expected to cause an adverse effect, and which brings the cleaning roller into contact with the charging roller only when the charging roller needs to be cleaned.

According to the method of keeping the cleaning roller separated from the charging roller described above, however, if the amount of toner passing through the cleaning position is increased due to, for example, consecutive feeding of sheets with areas of high image density, a relatively low temperature environment, and so forth, the formation of abnormal images due to the stains on the charging roller is neither prevented nor corrected until the time comes for the cleaning roller to clean the charging roller.

### SUMMARY OF THE INVENTION

The present invention describes a charging device controller. In one example, a charging device controller controls a charging device including a charging roller disposed facing an image carrying member to charge a surface of the image carrying member carrying a toner image, a cleaning roller disposed facing the charging roller to come into contact with the charging roller to remove therefrom foreign substances including toner, and a contact-separation device configured to make the cleaning roller come into contact with and separate from the charging roller. The charging device controller includes a contact-separation device controller to cause the contact-separation device to make the cleaning roller come into contact with and separate from the charging roller during an image forming operation, which includes a latent image writing operation of writing a latent image on the image carrying member and a development operation of forming a toner image by supplying toner to the latent image, at an operation other than the latent image writing operation performed on the image carrying member.

The operation may fall within a time period after the toner image formed on the image carrying member by the image forming operation is transferred onto a recording medium and before the next latent image writing operation on the image carrying member starts.

The above-described charging device controller may further include an image area ratio detection device to detect an image area ratio representing the ratio of the area of the toner image to the area of the recording medium carried by the image carrying member. The contact-separation device controller may change, in accordance with a result of the detection performed by the image area ratio detection device, the duration of time during which the cleaning roller is kept in contact with the charging roller by the contact-separation device.

The above-described charging device controller may further include a use environment detection device to detect a use environment of the charging device. The contact-separation device controller may change, in accordance with the result of the detection by the use environment detection device, the duration of time during which the cleaning roller is kept in contact with the charging roller by the contact-separation device.

The above-described charging device controller may further include an accumulated contact time detection device to detect an accumulated contact time of the cleaning blade which removes foreign substances adhering to the surface of the image carrying member. The contact-separation device controller may change, in accordance with the result of the detection by the accumulated contact time detection device, the duration of time during which the cleaning roller is kept in contact with the charging roller by the contact-separation device.

The contact-separation device controller may cause the contact-separation device to separate the cleaning roller from the charging roller upon completion of the image forming operation.

The present invention further describes an image forming apparatus. In one example, an image forming apparatus includes a charging device and a charging device controller. The charging device includes a charging roller disposed facing an image carrying member to charge a surface of the image carrying member carrying a toner image, a cleaning roller disposed facing the charging roller to come into contact with the charging roller to remove therefrom foreign substances including toner, and a contact-separation device to make the cleaning roller come into contact with and separate from the charging roller. The charging device controller controls the charging device and includes a contact-separation device controller to cause the contact-separation device to make the cleaning roller come into contact with and separate from the charging roller during an image forming operation, which includes a latent image writing operation of writing a latent image on the image carrying member and a development operation of forming a toner image by supplying toner to the latent image, at an operation other than the latent image writing operation performed on the image carrying member.

The present invention further describes a control method for controlling a charging device of an image forming apparatus. The charging device includes a charging roller to charge a surface of an image carrying member carrying a toner image, a cleaning roller to come into contact with the charging roller to remove therefrom foreign substances including toner, and a contact-separation device to make the cleaning roller come into contact with and separate from the charging roller. In one example, the control method includes contacting the cleaning roller against the charging roller during image formation at a time other than during a latent image writing operation of writing a latent image on the image carrying member, and separating the cleaning roller from the charging roller upon completion of the image forming operation.

### BRIEF DESCRIPTION OF THE DRAWINGS

A more complete appreciation of the invention and many of the advantages thereof are obtained as the same becomes better understood by reference to the following detailed description when considered in connection with the accompanying drawings, wherein:

FIG. 1 is a diagram illustrating a configuration example of a mechanical section of an image forming apparatus including a charging device controller according to an embodiment of the present invention;

FIG. 2 is a cross-sectional view illustrating an example of a schematic configuration of the development device of FIG. 1;

FIG. 3 is a cross-sectional view illustrating an example of a schematic configuration of another development device usable in the image forming apparatus illustrated in FIG. 1;

FIGS. 4A and 4B are diagrams illustrating a configuration example of a contact-separation unit for making the cleaning roller of FIG. 3 come into contact with and separate from the charging roller of FIG. 3;

FIGS. 5A and 5B are diagrams for explaining contacting and separating operations of the cleaning roller of FIG. 3;

FIG. 6 is a block diagram illustrating a configuration example of essential parts of a control system of the image forming apparatus illustrated in FIG. 1; and

FIGS. 7A and 7B are first and second halves of a flowchart illustrating an example of control relating to an embodiment of the present invention performed by the control unit of FIG. 6.

### DETAILED DESCRIPTION OF PREFERRED EMBODIMENTS

In describing the embodiments illustrated in the drawings, specific terminology is employed for the purpose of clarity. However, the disclosure of the present invention is not intended to be limited to the specific terminology so used, and it is to be understood that substitutions for each specific element can include any technical equivalents that operate in a similar manner.

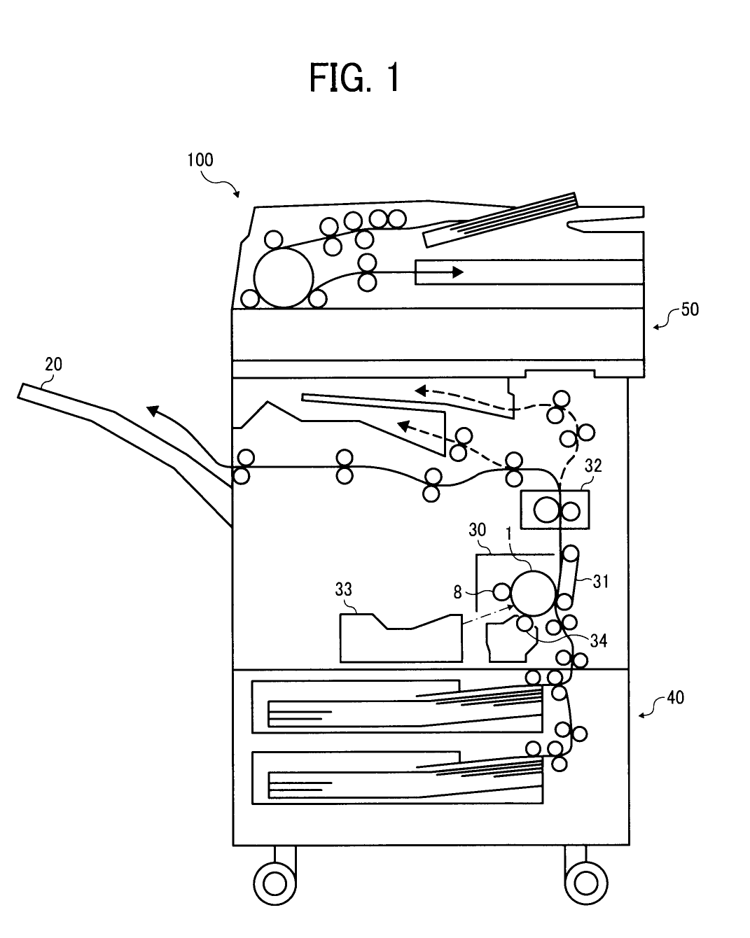

Referring now to the drawings, wherein like reference numerals designate identical or corresponding parts throughout the several views, particularly to FIG. 1, a preferred embodiment for implementing the present invention will be specifically described below.

A charging device controller according to an embodiment of the present invention controls a charging device included in an electrophotographic development device.

The charging device is attached to the electrophotographic development device including a photoconductor which serves as an image carrying member for carrying a toner image, a development roller which develops a latent image formed on a surface of the photoconductor, and a photoconductor cleaning device which cleans the surface of the photoconductor.

The charging device includes a charging roller which charges the surface of the photoconductor, and a cleaning device which comes into contact with and cleans the charging roller, i.e., removes foreign substances including toner from the charging roller. The cleaning device is configured to include a cleaning roller and a mechanism including a contact-separation unit (contact-separation device) which makes the cleaning roller come into contact with and separate from the charging roller.

The development device including the charging device can be attached and detached, integrally as a process cartridge, with respect to an apparatus body, i.e., the body of an image forming apparatus, which performs an image forming operation by using the photoconductor.

An image forming apparatus including the above-described development device will now be described in detail. With reference to FIG. 1, description will be first made of an image forming apparatus including the charging device controller according to an embodiment of the present invention. FIG. 1 is a diagram illustrating a configuration example of a mechanical section of an image forming apparatus including the charging device controller according to an embodiment of the present invention.

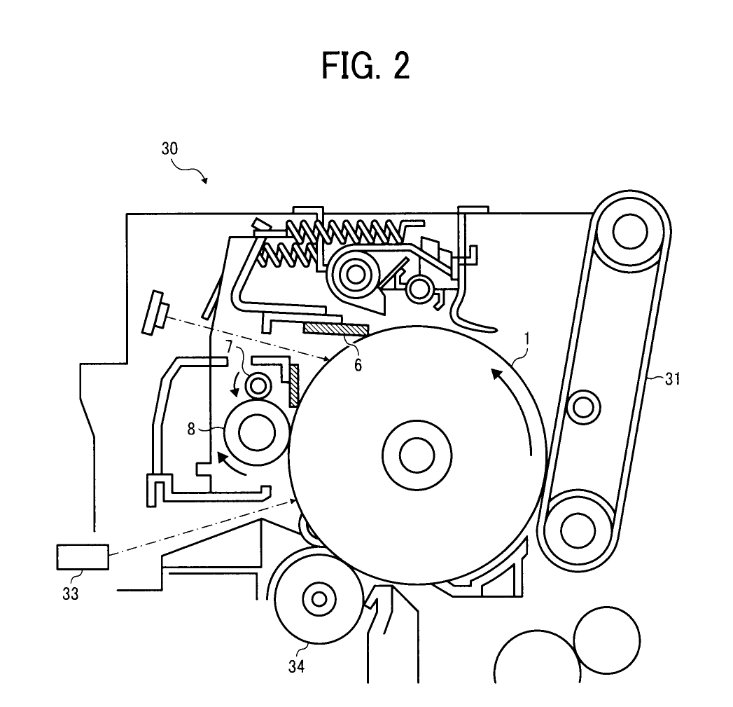

An image forming apparatus 100, which is a digital copier, includes an image reading unit (scanner) 50 in an upper part thereof. The image forming apparatus 100 further includes an image forming unit located below the image reading unit 50. The image forming unit includes a development device 30 including a photoconductor 1, a charging device including a charging roller 8, and a development roller 34 for forming an image on a recording medium such as a recording sheet, a transfer belt 31, a fixing device 32, and an exposure device 33. The image forming apparatus 100 further includes a recording medium storage unit 40 located in the lowermost part thereof to feed the recording medium therefrom, and a tray 20. The charging device is included in the development device 30, and includes the cleaning device adjacent to the charging roller 8. Although the illustration of the cleaning device is omitted in FIG. 1, FIG. 2 (described later) as an enlarged view of the development device 30 illustrates a cleaning roller 7, which is an essential component of the cleaning device.

In the image forming apparatus 100, image information (image data) read from a document as electronic information by the image reading unit 50 is converted into optical information by the exposure device 33 of the image forming unit, and is first recorded in the development device 30 as a latent image. The image information recorded as the latent image is then developed into a toner image with toner supplied by the development roller 34. The image information developed into the toner image is transferred by the transfer belt 31 onto the recording medium (normally recording sheet) fed from the recording medium storage unit 40, and is discharged onto the tray 20 provided on the left side of the image forming apparatus 100 as the image information fixed by the fixing device 32 and formed on the recording medium.

Subsequently, with reference to FIG. 2, a schematic configuration of the development device 30 of FIG. 1 will be described. FIG. 2 is a cross-sectional view illustrating an example of the schematic configuration of the development device 30 of FIG. 1. The development device 30 includes the photoconductor 1, the development roller 34, the charging device including the charging roller 8, and the photoconductor cleaning device including a cleaning blade 6, and forms a process cartridge integrally attachable and detachable with respect to the apparatus body which performs the image forming operation by using the photoconductor 1. The charging device includes the charging roller 8 and the cleaning device which includes the cleaning roller 7.

The operation of the development device 30 is performed as follows. That is, a latent image based on the difference in charge is formed (written) on a surface of the photoconductor 1 uniformly charged by the charging roller 8 that rotates in a direction as indicated by arrow show in FIG. 2, in accordance with the optical information received from the exposure device 33, e.g., laser beam modulated in accordance with the image data, while the photoconductor 1 rotates in the counterclockwise direction as indicated by arrow show in FIG. 2. With the toner supplied by the development roller 34, the formed latent image is developed into a toner image on the surface of the photoconductor 1.

The toner image formed on the surface of the photoconductor 1 is transferred by the transfer belt 31 onto the fed recording medium. The photoconductor 1 continues to rotate after the transfer process, and the photoconductor cleaning device including the cleaning blade 6 removes stains such as post-transfer residual toner, i.e., foreign substances including the toner, remaining on the surface of the photoconductor 1. The surface of the photoconductor 1, from which the stains have been removed, is charged again by the charging roller 8, and the development process is repeated.

Herein, there is no problem if the stains to be removed by the photoconductor cleaning device are completely removed to make the surface of the photoconductor 1 completely clean. Normally, however, the charging process is performed with a part of the post-transfer residual toner and so forth remaining unremoved on the surface of the photoconductor 1. As a result, the stains also adhere to a surface of the charging roller 8, and prevent the charging roller 8 from uniformly charging the surface of the photoconductor 1.

The cleaning roller 7 of the cleaning device included in the charging device is provided to remove the above-described stains such as the post-transfer residual toner on the surface of the charging roller 8, and thus to maintain the charging performance of the charging roller 8 to uniformly charge the surface of the photoconductor 1.

The cleaning roller 7, which is in contact with the charging roller 8, can be separated from the charging roller 8 by the later-described contact-separation unit. The cleaning roller 7 is pressed against the charging roller 8 under the weight thereof and by a not-illustrated spring. Accordingly, the cleaning roller 7 is easily rotated in a direction indicated by arrow in FIG. 2 in accordance with the rotation of the charging roller 8. Further, the post-transfer residual toner and so forth on the charging roller 8 are easily removed.

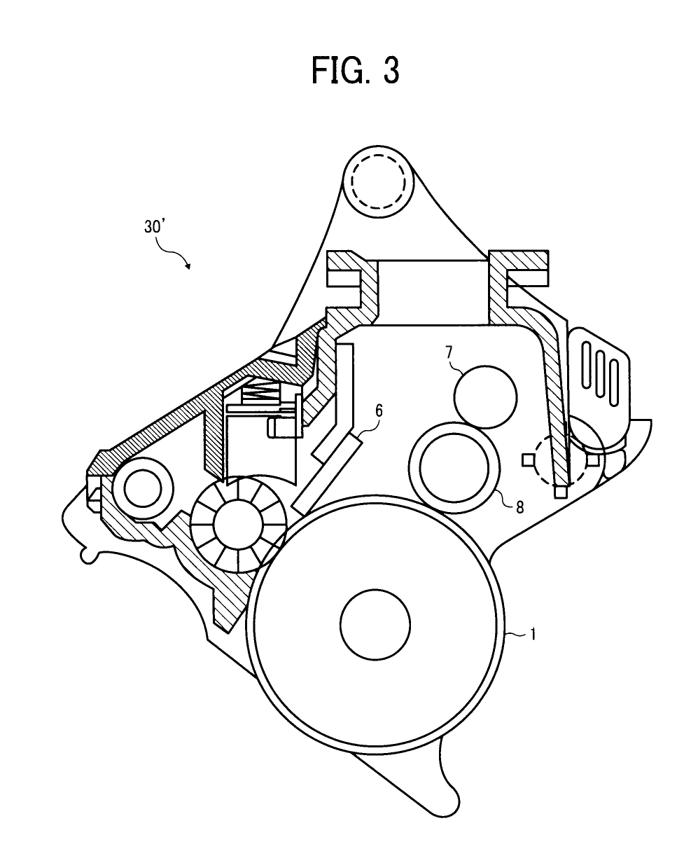

FIG. 3 is a cross-sectional view illustrating an example of a schematic configuration of another development device usable in the image forming apparatus 100 illustrated in FIG. 1. In the drawing, components corresponding to the components of FIG. 2 are designated with the same reference numerals. In FIG. 3, the illustration of a portion including the development roller 34 is omitted. A development device 30′ is different in configuration from the development device 30 illustrated in FIG. 2, but has a cleaning device similar in configuration to the cleaning device of FIG. 2 and including the cleaning roller 7 which comes into contact with the charging roller 8 to remove stains (foreign substances) on the surface of the charging roller 8.

The contact-separation unit which makes the cleaning roller 7 in the above-described development device 30 or 30′ come into contact with and separate from the charging roller 8, i.e., the contact-separation unit which makes the cleaning roller 7 separate from and come into contact (touch) with the charging roller 8 (hereinafter simply referred to as “contact-separation unit” in some cases) may take any configuration, as long as the contact-separation unit is capable of making the cleaning roller 7 come into contact with and separate from the charging roller 8 in accordance with the detection result of the image area ratio, the use environment of the charging device, the accumulated contact time of the cleaning blade 6, and so forth, which will be described later.

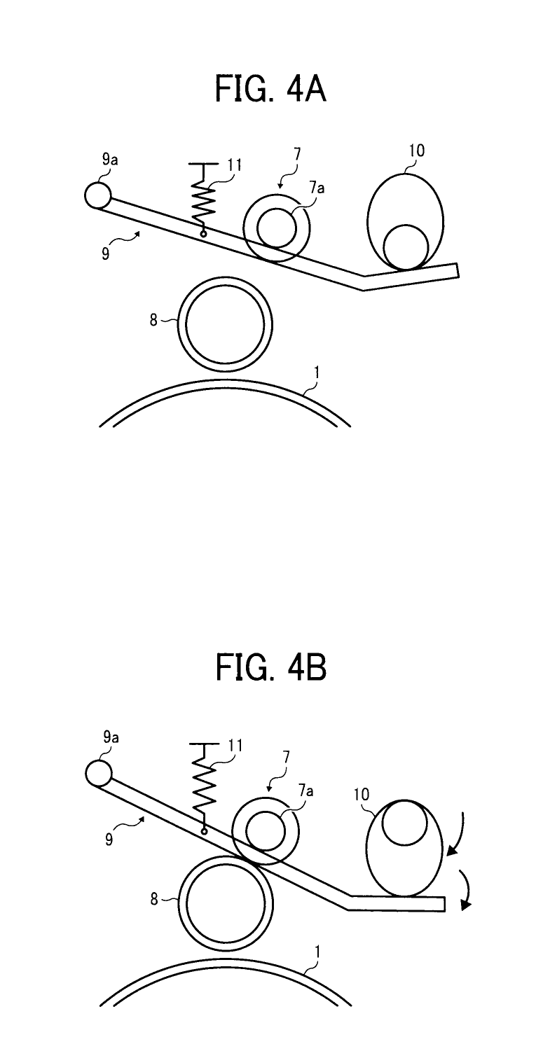

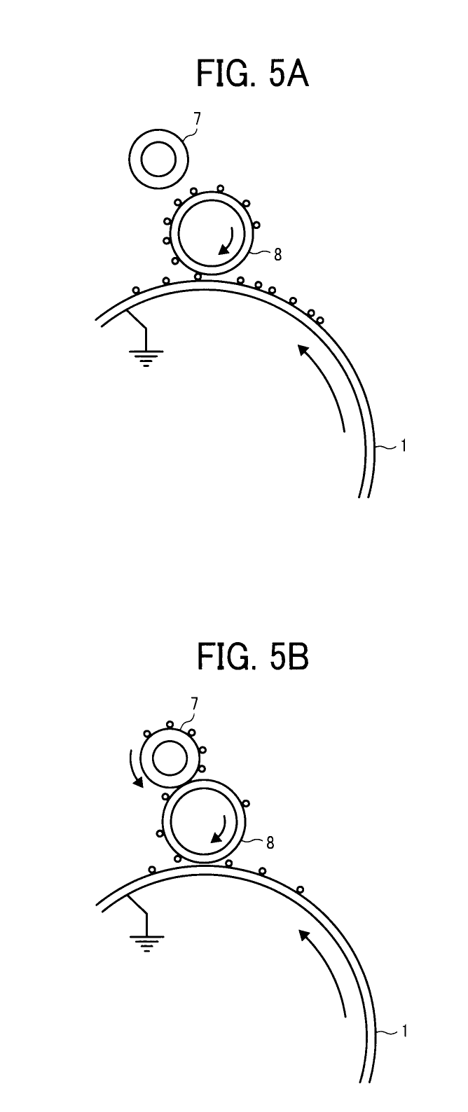

Subsequently, with reference to FIGS. 4A to 5B, description will be made of a configuration of a part of the contact-separation unit which makes the cleaning roller 7 of FIG. 3 come into contact with and separate from the charging roller 8 of FIG. 3, and contacting and separating operations of the contact-separation unit. FIGS. 4A and 4B are diagrams illustrating a configuration example of the contact-separation unit which makes the cleaning roller 7 of FIG. 3 come into contact with and separate from the charging roller 8 of FIG. 3. FIGS. 5A and 5B are diagrams for explaining the contacting and separating operations of the cleaning roller 7 of FIG. 3. The position of the cleaning roller 7 in FIGS. 5A and 5B is different from the position of the cleaning roller 7 in FIGS. 4A and 4B for convenience of illustration.

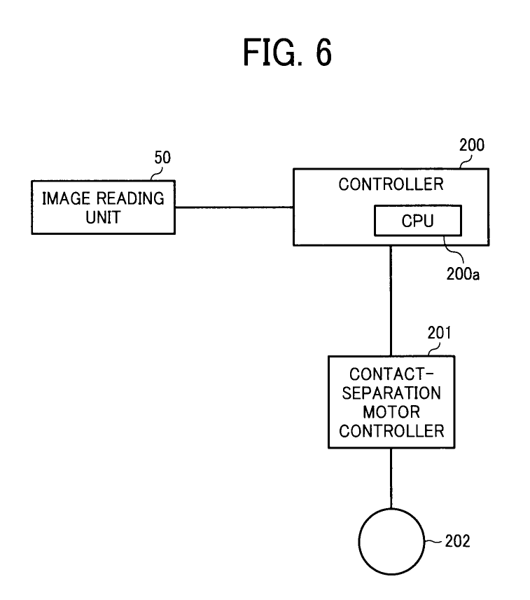

In the example of the contact-separation unit illustrated in FIGS. 4A and 4B, a release lever 9 is operated by a contact-separation cam 10 rotated by a later-described contact-separation motor 202 in FIG. 6. Thereby, the cleaning roller 7 is brought into contact with and separated from the charging roller 8. With reference to FIGS. 4A to 5B, when the cleaning roller 7 separates from the charging roller 8, as illustrated in FIG. 5A, the release lever 9 is pulled by a separation spring 11, as illustrated in FIG. 4A. Thereby, the release lever 9 is rotated in the counterclockwise direction with a shaft 9a acting as a fulcrum, and a shaft 7a on the opposite ends of the cleaning roller 7 is pressed upward. As a result, the cleaning roller 7 is separated from the charging roller 8.

By contrast, when the cleaning roller 7 comes into contact with the charging roller 8, as illustrated in FIG. 5B, the release lever 9 is pressed downward in accordance with the rotation of the contact-separation cam 10 in the direction indicated by the corresponding arrow, as illustrated in FIG. 4B. Thereby, the cleaning roller 7 is brought into contact with the charging roller 8 under the weight thereof or by a not-illustrated spring. In the present example, the release lever 9 is operated by the contact-separation cam 10 rotated by the contact-separation motor 202. Alternatively, a mechanism using a contact-separation solenoid and so forth may be used.

Preferably, the cleaning roller 7 is rotatably supported and rotated in accordance with the rotation of the charging roller 8. If the cleaning roller 7 is thus driven by the rotation of the charging roller 8, the cleaning roller 7 does not require a driving device, and thus can have a simple configuration. Further, an outer circumferential portion of the cleaning roller 7 is preferably formed by resin foam. With this configuration, sufficient cleaning performance can be obtained with no need for strong pressing force for bringing the cleaning roller 7 into contact with the surface of the charging roller 8. Accordingly, the abrasion of the surface of the charging roller 8 can also be suppressed.

An example of the material forming the cleaning roller 7 will now be described.

The cleaning roller 7 may include a resin foam layer formed by, for example, resin foam wound around a core bar into a cylindrical shape. The resin foam may have a continuous bubble structure with physical property values including a density in a range of from approximately 5 kg/m³ (kilograms per cubic meter) to approximately 15 kg/m³ and a tensile strength in a range of approximately 1.7±0.5 kg/cm² (kilograms per square centimeter).

The cleaning performance and the damage on the surface of the charging roller 8 can be evaluated on the basis of the state of a formed image. That is, if stains adhere to the surface of the charging roller 8 due to insufficient cleaning performance of the cleaning roller 7, the photoconductor 1 is poorly charged, and scumming occurs in the recording sheet (recording medium), and the state of the formed image is deteriorated. Further, if the surface of the charging roller 8 is damaged due to the rubbing of the cleaning roller 7, defects such as streaks appear in an image.

If the density of the resin foam is equal to or greater than approximately 5 kg/m³, sufficient cleaning performance of the cleaning roller 7 is obtained. If the density of the resin foam is smaller than approximately 5 kg/m³, sufficient cleaning performance is not obtained. As a result, a charging failure occurs at an early stage, and defects such as scumming occur in an image. Meanwhile, if the density of the resin foam is greater than approximately 15 kg/m³, favorable cleaning performance is obtained, but the amount of abrasion of the surface of the charging roller 8 is increased. As a result, the surface of the charging roller 8 is damaged at an early stage, and defects such as streaks tend to appear in an image.

Further, if the tensile strength of the resin foam is equal to or greater than approximately 1.2 kg/cm², the cleaning roller 7 exhibits sufficient cleaning performance. If the tensile strength of the resin foam is smaller than approximately 1.2 kg/cm², the strength of the cleaning roller 7 is insufficient. As a result, the resin foam is worn away at an early stage, and favorable cleaning performance is not exhibited. Meanwhile, if the tensile strength of the resin foam is greater than approximately 2.2 kg/cm², favorable cleaning performance is exhibited. However, the surface of the charging roller 8 is damaged at an early stage, and defects such as streaks appear in an image.

Accordingly, as the physical property values of the resin foam forming the cleaning roller 7, the density and the tensile strength of the resin foam are desired to be in a range of from approximately 5 kg/m³ to approximately 15 kg/m³ and a range of approximately 1.7±0.5 kg/cm², respectively.

The resin foam having a continuous bubble structure with a density in the above-described range is reticulated with minute air cells. The resin foam includes a skeletal portion capable of scraping off deposits such as the toner adhering to the surface of the charging roller 8. Further, the resin foam having a tensile strength in the above-described range exhibits brittle characteristics, and is peeled off by the frictional force received by a surface of the rein foam in contact with the charging roller 8. At the same time, the deposits such as the toner held in the air cells of the resin foam are also peeled off. Therefore, the present resin foam does not accumulate the deposits in the air cells thereof, unlike related-art resin foam, and thus can perform the cleaning by using a constantly fresh surface thereof. Further, the present resin foam can exhibit favorable cleaning performance over a long period of time without damaging the surface of the charging roller 8.

Among various types of resin foam having the above-described physical property values, melamine resin foam is particularly preferable. Foam made of melamine resin forms hard reticulated fibers. Therefore, deposits adhering to the charging roller 8 can be easily scraped away or caught and peeled away by the foam. The melamine resin foam thus exhibits favorable cleaning performance and the above-described brittle characteristics. Therefore, the fresh surface of the cleaning roller 7 is constantly in contact with the surface of the charging roller 8, and favorable cleaning performance can be maintained. In particular, the use of the melamine resin foam increases the removal efficiency of the deposits such as the toner adhering to the charging roller 8, and thus can prevent the formation of an abnormal image. The charging roller 8 and the cleaning roller 7 are separate from each other, and are brought into contact with each other only when necessary. Therefore, the toner collection ability of the melamine resin foam is not saturated, and the allowance for the abnormal image is increased.

Preferably, melamine resin foam foamed and compressed to approximately 20 percent by volume to approximately 40 percent by volume is used as the resin foam for the cleaning roller 7. In the melamine resin foam foamed and compressed to approximately 20 percent by volume to approximately 40 percent by volume, the air bubbles formed in the initial foaming process are reduced in diameter due to the compression process. Therefore, the melamine resin foam can prevent the surface of the charging roller 8 from being unevenly cleaned.

Subsequently, with reference to FIG. 6, description will be made of the configuration of essential parts of a control system of the image forming apparatus 100 illustrated in FIG. 1. In the following description, the recording medium will be assumed to be a recording sheet. FIG. 6 is a block diagram illustrating a configuration example of the essential parts of the control system of the image forming apparatus 100 illustrated in FIG. 1.

A control unit 200 of the image forming apparatus 100 uses a microcomputer (hereinafter simply referred to as “CPU”) 200a including a central processing unit (microprocessor), a ROM (Read-Only Memory) storing a variety of programs including a program relating to an embodiment of the present invention and other fixed data, a RAM (Random Access Memory), a nonvolatile memory, and so forth, and integrally controls the entire image forming apparatus 100.

The control unit 200 can make the cleaning roller 7 come into contact with the charging roller 8 by outputting, to a contact-separation motor control unit 201, a signal for driving a contact-separation motor 202, i.e., a motor for rotating the contact-separation cam 10 of FIGS. 4A and 4B, which forms the contact-separation unit for making the cleaning roller 7 come into contact with and separate from the charging roller 8. Further, the control unit 200 can make the cleaning roller 7 separate from the charging roller 8 by stopping the output of the signal.

The control unit 200 performs the following control relating to an embodiment of the present invention. That is, the control unit 200 causes the contact-separation motor 202 to make the cleaning roller 7 come into contact with and separate from the charging roller 8 during the image forming operation, which includes the latent image writing operation of writing a latent image on the photoconductor 1 and the development operation of forming a toner image by supplying toner to the latent image, at an operation other than the latent image writing operation performed on the photoconductor 1. The above-described operation may be set in a recording sheet interval, i.e., in a time period after the toner image formed on the photoconductor 1 by the image forming operation is transferred (formed) on a recording sheet and before the next latent image writing operation on the photoconductor 1 starts.

Further, the duration of time during which the cleaning roller 7 is kept in contact with the charging roller 8 by the contact-separation motor 202 may be changed in accordance with the detection result of the image area ratio representing the area ratio of the toner image (e.g., a black image) carried by the photoconductor 1, the use environment of the charging device, or the accumulated contact time of the cleaning blade 6. Further, the cleaning roller 7 may be separated from the charging roller 8 by the contact-separation motor 202 upon completion of the image forming operation.

Herein, the time of the operation of making the cleaning roller 7 come into contact with the charging roller 8 is desired to correspond to the time of an operation other than the latent image writing operation during the image forming operation, i.e., the time corresponding to the recording sheet interval. This is because, when the cleaning roller 7 is in contact with the charging roller 8, vibrations of the cleaning roller 7 are transmitted to the photoconductor 1 via the charging roller 8, and thus may cause a rotation error of the photoconductor 1.

Further, the image forming apparatus 100 is the digital copier illustrated in FIG. 1. Therefore, the image data read from a document by the image reading unit 50 is extracted into a not-illustrated image memory. Further, if the image forming apparatus 100 also has the function of a printer, and if print data received from an external device such as a not-illustrated PC (Personal Computer) is image data, the data is directly extracted into the image memory. If the print data received from the external device is data other than image data, such as text coded data and drawing data, the data is converted into image data and extracted into the image memory. Accordingly, the area ratio of the toner image carried by the photoconductor 1 can be calculated (detected) when necessary on the basis of the image data extracted into the image memory.

The use environment of the charging device refers to the temperature and humidity (or one of the temperature and humidity) of an area around the charging device, which can be detected by a not-illustrated environment sensor including a temperature sensor and a humidity, sensor. It is known that the adhesion of foreign substances to the charging roller 8 is more likely to affect images in a relatively low-temperature and low-humidity environment, causing density unevenness (e.g., streaks) in images, and is less likely to affect images in a relatively high-temperature and high-humidity environment. Therefore, on the basis of the temperature and humidity of the area around the charging device detected by the environment sensor, the duration of time during which the cleaning roller 7 is kept in contact with the charging roller 8 may be reduced in a relatively low-temperature and low-humidity environment and increased in a relatively high-temperature and high-humidity environment. That is, the time in which the cleaning roller 7 is kept in contact with the charging roller 8 may be increased in a relatively high-temperature and high-humidity environment and reduced in a relatively low-temperature and low-humidity environment.

The accumulated contact time of the cleaning blade 6 is measured by a not-illustrated timer counter and stored and retained in a nonvolatile memory. Thereby, the accumulated contact time can be read (detected) when necessary.

Therefore, as the CPU 200a of the control unit 200 executes the program stored in the ROM and controls the contact-separation motor control unit 201 and so forth, the functions of a contact-separation device controller, an image area ratio detection device, a use environment detection device, and an accumulated contact time detection device can be performed.

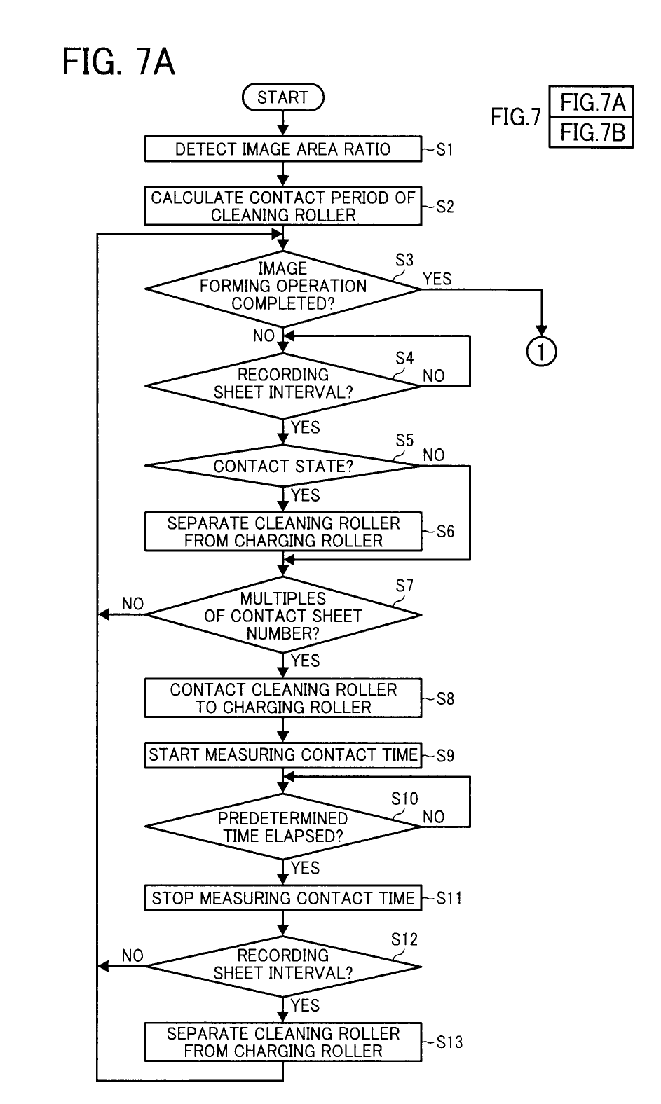

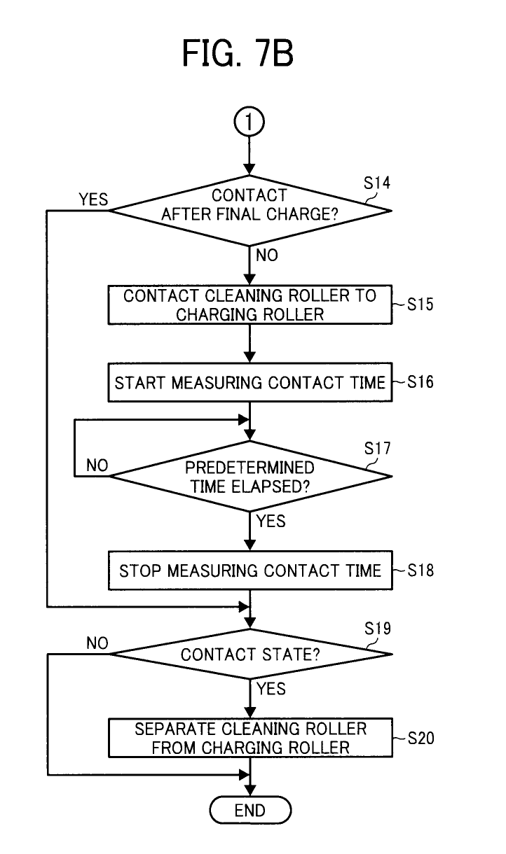

Subsequently, with reference to FIG. 7, description will be made of the control relating to an embodiment of the present invention performed by the control unit 200 of FIG. 6. The present control example described below includes the detection (calculation) of the image area ratio. The detection of the image area ratio may be replaced by the detection of the use environment of the charging device or the accumulated contact time of the cleaning blade 6.

FIGS. 7A and 7B are first and second halves of a flowchart illustrating an example of the control relating to an embodiment of the present invention performed by the control unit 200 of FIG. 6.

The control unit 200 starts controlling the image forming operation performed by the foregoing image forming unit, and at the same time starts the control (processing routine) illustrated in FIGS. 7A and 7B.

At step S1 of FIG. 7A, the control unit 200 first detects (calculates) the image area ratio. Then, at step S2, the control unit 200 calculates the duration of time during which the cleaning roller 7 is kept in contact with the charging roller 8 (hereinafter referred to as “contact duration” in some cases) in accordance with the detection result. Although illustration is omitted here, the control unit 200 also calculates, on the basis of the calculated contact duration, an image formation sheet number corresponding to the time of bringing the cleaning roller 7 into contact with the charging roller 8 (hereinafter referred to as “contact sheet number” in some cases).

Subsequently, at step S3, the control unit 200 determines whether or not the image forming operation has been completed. In this case, the image forming operation has just started (NO at step S3). At step 4, therefore, the control unit 200 stands by until the arrival of the recording sheet interval.

Then, upon arrival of the recording sheet interval (YES at step S4), i.e., immediately after the toner image formed on the photoconductor 1 by the image forming operation is transferred onto a recording sheet (corresponding to an operation other than the latent image writing operation performed on the photoconductor 1) in this case, the control unit 200 moves to step S5 to determine whether or not the cleaning roller 7 is in contact with the charging roller 8 (hereinafter referred to as “contact state” in some cases). In this case, the image forming operation has just started, and thus the cleaning roller 7 is not in the contact state (NO at step S5). Therefore, the control unit 200 moves to step S7.

At step S7, the control unit 200 determines whether or not the image formation sheet number has reached a multiple of the contact sheet number calculated at step S2. The image formation sheet number can be measured by, for example, a not-illustrated timer counter.

If the image formation sheet number has not reached a multiple of the contact sheet number (NO at step S7), the control unit 200 returns to step S3 to determine again whether or not the image forming operation has been completed. If the image forming operation has been completed (YES at step S3), the control unit 200 moves to step S14. If the image forming operation has not been completed (NO at step S3), the control unit 200 moves again to step S4 to perform the processes described above. Then, if the image formation sheet number reaches a multiple of the contact sheet number (YES at step S7), the control unit 200 moves from step S7 to step S8 to make the cleaning roller 7 comes into contact with the charging roller 8.

Then, the control unit 200 moves to step S9 to start measuring the time elapsed after the contact of the cleaning roller 7 with the charging roller 8 (hereinafter referred to as “contact time” in some cases). The elapsed time can be measured by a not-illustrated timer counter.

Thereafter, at step S10, the control unit 200 stands by until the contact time reaches a preset predetermined time, i.e., an optimal time for cleaning. Then, at step S11, the control unit 200 stops measuring the contact time. The process of this step also includes the resetting of the measurement time to zero. Thereafter, at step S12, the control unit 200 determines whether or not the recording sheet interval has arrived.

Then, if the recording sheet interval has arrived (YES at step S12), i.e., if the next latent image writing operation on the photoconductor 1 has not been started in this case, the control unit 200 moves to step S13 to separate the cleaning roller 7 from the charging roller 8.

If the recording sheet interval has not arrived (NO at step S12), i.e., if the next latent image writing operation on the photoconductor 1 has been started in this case, the control unit 200 returns to step S3 to determine again whether or not the image forming operation has been completed. If the image forming operation has not been completed (NO at step S3), the control unit 200 stands by at step S4 until the arrival of the recording sheet interval. Then, the control unit 200 moves to step S5 to determine again whether or not the cleaning roller 7 is in the contact state.

In this case, the cleaning roller 7 is still in the contact state (YES at step S5). Therefore, the control unit 200 moves to step S6 to separate the cleaning roller 7 from the charging roller 8, and moves to the next step S7.

Meanwhile, if the control unit 200 returns to step S3 and determines that the image forming operation has been completed (YES at step S3), the control unit 200 moves process 1 to step S14 in FIG. 7B to determine whether or not the cleaning roller 7 has been made in contact with the charging roller 8 after the final charging by the charging roller 8. If the cleaning roller 7 has been made in contact with the charging roller 8 after the final charging by the charging roller 8 (YES at step S14 of FIG. 7B), the control unit 200 moves to step S19.

If the cleaning roller 7 has not been made in contact with the charging roller 8 after the final charging by the charging roller 8 (NO at step S14 of FIG. 7B), the control unit 200 makes the cleaning roller 7 come into contact with the charging roller 8 at step S15. Then, the control unit 200 starts measuring the contact time at step S16, and stands by at step S17 until the contact time reaches a preset predetermined time. Then, at step S18, the control unit 200 stops measuring the contact time. The process of this step also includes the resetting of the measurement time to zero. Thereafter, the control unit 200 determines at step S19 whether or not the cleaning roller 7 is in the contact state. If the cleaning roller 7 is not in the contact state (NO at step S19), the control unit 200 completes the control of FIGS. 7A and 7B. If the cleaning roller 7 is in the contact state (YES at step S19), the control unit 200 separates the cleaning roller 7 from the charging roller 8 at step S20, and completes the control of FIGS. 7A and 7B.

The time period after the cleaning roller 7 is brought into contact with the charging roller 8 by the contact-separation motor 202 and before the cleaning roller 7 is separated from the charging roller 8 by the contact-separation motor 202 may be changed in accordance with the detection result of the image area ratio representing the image ratio of the toner image carried by the photoconductor 1, the use environment of the charging device, or the accumulated contact time of the cleaning blade 6.

As described above, a cleaning roller is brought into contact with and separated from a charging roller during an image forming operation, which includes a latent image writing operation of writing a latent image on a photoconductor (image carrying member) and a development operation of forming a toner image by supplying toner to the latent image, at an operation other than the latent image writing operation performed on the photoconductor. Thereby, post-transfer residual toner and so forth adhering to a surface of the charging roller during the image forming operation are prevented from firmly adhering thereto. At the same time, the surface of the charging roller is cleaned to remove therefrom the post-transfer residual toner and so forth harmful to the development process. Accordingly, it is possible to extend the life of the charging roller. Further, due to the extended life of the charging roller, development troubles attributed to charging failure of the photoconductor are reduced.

Further, the above-described development device can be used as a process cartridge as illustrated in FIG. 2 or 3, which is formed to be attachable and detachable with respect to an apparatus body, includes at least a photoconductor and a charging device, and includes and integrally supports arbitrary devices selected from a development roller, a photoconductor cleaning device, and so forth. Provided with a cleaning device, the development device (process cartridge) appropriately cleans the surface of the charging roller to maintain uniform charging performance. Further, the charging performance of the charging roller is not impaired until the end of the life of the development device.

An image forming apparatus including the above-described development device is not limited to the configuration illustrated in FIG. 1. Therefore, the image forming apparatus may be configured to include an intermediate transfer member for temporality carrying the toner image formed on the photoconductor and transferred thereto, or to include a plurality of photoconductors for forming a multi-color image.

An image record formed by the image forming apparatus using the above-described development device is clear without defects such as scumming and streaks in the image recorded on a surface of a recording medium such as a recording sheet.

The above-described embodiments are illustrative and do not limit the present invention. Thus, numerous additional modifications and variations are possible in light of the above teachings. For example, elements at least one of features of different illustrative and exemplary embodiments herein may be combined with each other at least one of substituted for each other within the scope of this disclosure and appended claims. Further, features of components of the embodiments, such as the number, the position, and the shape are not limited the embodiments and thus may be preferably set. It is therefore to be understood that within the scope of the appended claims, the disclosure of the present invention may be practiced otherwise than as specifically described herein.

1. A charging device controller that controls a charging device including a charging roller disposed facing an image carrying member to charge a surface of the image carrying member carrying a toner image, a cleaning roller disposed facing the charging roller to come into contact with the charging roller to remove therefrom foreign substances including toner, and a contact-separation device configured to make the cleaning roller come into contact with and separate from the charging roller,
the charging device controller comprising:
a contact-separation device controller to cause the contact-separation device to make the cleaning roller come into contact with and separate from the charging roller during an image forming operation, which includes a latent image writing operation of writing a latent image on the image carrying member and a development operation of forming a toner image by supplying toner to the latent image, at an operation other than the latent image writing operation performed on the image carrying member.

2. The charging device controller according to claim 1, wherein the operation falls within a time period after the toner image formed on the image carrying member by the image forming operation is transferred onto a recording medium and before the next latent image writing operation on the image carrying member starts.

3. The charging device controller according to claim 1, further comprising:
an image area ratio detection device to detect an image area ratio representing the ratio of the area of the toner image to the area of the recording medium carried by the image carrying member,
wherein the contact-separation device controller changes, in accordance with a result of the detection performed by the image area ratio detection device, the duration of time during which the cleaning roller is kept in contact with the charging roller by the contact-separation device.

4. The charging device controller according to claim 1, further comprising:
a use environment detection device to detect a use environment of the charging device,
wherein the contact-separation device controller changes, in accordance with the result of the detection by the use environment detection device, the duration of time during which the cleaning roller is kept in contact with the charging roller by the contact-separation device.

5. The charging device controller according to claim 1, further comprising:
an accumulated contact time detection device to detect an accumulated contact time of the cleaning blade which removes foreign substances adhering to the surface of the image carrying member,
wherein the contact-separation device controller changes, in accordance with the result of the detection by the accumulated contact time detection device, the duration of time during which the cleaning roller is kept in contact with the charging roller by the contact-separation device.

6. The charging device controller according to claim 1, wherein the contact-separation device controller causes the contact-separation device to separate the cleaning roller from the charging roller upon completion of the image forming operation.

7. An image forming apparatus comprising:
a charging device including
a charging roller disposed facing an image carrying member to charge a surface of the image carrying member carrying a toner image,
a cleaning roller disposed facing the charging roller to come into contact with the charging roller to remove therefrom foreign substances including toner, and
a contact-separation device to make the cleaning roller come into contact with and separate from the charging roller; and
a charging device controller to control the charging device,
the charging device controller including a contact-separation device controller configured to cause the contact-separation device to make the cleaning roller come into contact with and separate from the charging roller during an image forming operation, which includes a latent image writing operation of writing a latent image on the image carrying member and a development operation of forming a toner image by supplying toner to the latent image, at an operation other than the latent image writing operation performed on the image carrying member.

8. A control method for controlling a charging device of an image forming apparatus, the charging device including a charging roller to charge a surface of an image carrying member carrying a toner image, a cleaning roller to come into contact with the charging roller to remove therefrom foreign substances including toner, and a contact-separation device to make the cleaning roller come into contact with and separate from the charging roller,
the method comprising:
contacting the cleaning roller against the charging roller during image formation at a time other than during a latent image writing operation of writing a latent image on the image carrying member; and
separating the cleaning roller from the charging roller upon completion of the image forming operation.
